(19) United States
(12) Patent Application Publication
(10) Pub. No.: US 2026/0194151 A1
(43) Pub. Date: Jul. 9, 2026

(54) SOLENOID VALVE UNIT, CLEANING DEVICE, AND VEHICLE

(71) Applicant: Schaeffler Technologies AG & Co. KG, Herzogenaurach (DE)

(72) Inventors: Johannes DEICHMANN, Rotenburg (DE); Jens MISSUN, Lohfelden (DE); Matthias FISCHER, Ringgau (DE); Andreas SCHMICK, Rotenburg (DE); Wolf GOETZE, Rotenburg (DE); Bernd JÄGER, Fritzlar (DE)

(21) Appl. No.: 19/133,407

(22) PCT Filed: Nov. 29, 2023
(86) PCT No.: PCT/EP2023/083582

§ 371 Date: May 28, 2025

(30) Foreign Application Priority Data
Dec. 1, 2022 (DE) 10 2022 212 982.2

(51) Int. Cl. F16K 11/24; F16K 27/00; F16K 27/02; F16K 31/06

(52) U.S. Cl. CPC F16K 11/24; F16K 27/003; F16K 27/0263; F16K 27/029; F16K 31/0624

(57) ABSTRACT

A solenoid valve unit having at least four solenoid valves each having an electromagnet and each being fluidically connectable via an associated outlet to one of the cleaning points of a vehicle, a housing having at least one central supply line with at least one fluid inlet for providing a pressurized fluid in the supply line. The solenoid valves are joined to the housing transversely with respect to the supply line. Two solenoid valves, which lie opposite each other and are arranged transversely with respect to the supply line and between which the supply line is located, form a modularly extended pair of solenoid valves, the common housing portion of which is extended either at one end or at both ends of the supply line by a housing portion of a further pair of solenoid valves by a joining connection and/or an integrally bonded connection.

### CROSS REFERENCE TO RELATED APPLICATIONS

This is a U.S. national stage of Application No. PCT/EP 2023/083582 filed Nov. 29, 2023. Priority is claimed on German Application No. DE 10 2022 212 982.2 filed Dec. 1, 2022, the contents of which are incorporated herein by reference.

### BACKGROUND OF THE INVENTION

### 1. Field of the Invention

The disclosure relates to a solenoid valve unit for distributing a pressurized fluid to individual cleaning points of a device, in particular a vehicle, a cleaning device having such a solenoid valve unit, in particular for a vehicle, and a vehicle having such a cleaning device.

### 2. Description of the Related Art

CN 214823154 U discloses a fluid distribution device in the form of a solenoid valve block.

### SUMMARY OF THE INVENTION

It is an object of one aspect of the invention to improve a distribution of water for a device cleaning arrangement, in particular for a vehicle cleaning arrangement, specifically in view of the increasing number of vehicle sensors.

A solenoid valve unit for distributing a pressurized fluid to individual cleaning points or points to be cleaned of a device, in particular of a vehicle, is proposed. The solenoid valve unit has at least four solenoid valves each having an electromagnet and each being fluidically connectable via an associated outlet to one of the cleaning points, and a housing having at least one central supply line with at least one fluid inlet for providing the pressurized fluid in the supply line. The solenoid valves are joined to the housing transversely with respect to the supply line.

It is proposed to design the solenoid valve unit in such a way that two solenoid valves, which lie opposite each other and are arranged transversely with respect to the supply line and between which the supply line is located, form a modularly extended pair of solenoid valves, the common housing portion of which is extended either at one end or at both ends of the supply line by a housing portion of a further pair of solenoid valves by a joining connection and/or an integrally bonded connection.

Such a pair of solenoid valves is a simple basic unit which, in the sense of a smallest possible solenoid valve unit, provides the basis for a so-called modular system from which advantageously any number of pairs of solenoid valves of this type as required can be extended or assembled to form a correspondingly larger solenoid valve unit.

The joining connection between two housing sections joined together can be, for example, in the form of a so-called bayonet connection and the like.

Analogously thereto, the individual solenoid valves can also be joined to the associated or common housing section by a joining connection-for example in the form of said bayonet connection and the like-and/or an integrally bonded connection.

In this case, a cleaning point can be understood to mean a cleaning point which is associated with a vehicle sensor. Here, this cleaning point need not itself be part of the sensor, but may be arranged at a distance from the associated sensor, for example may be a point on a windshield or the like. The cleaning point may, however, also be part of a vehicle sensor, for example a cleaning point associated with a camera. A cleaning point may, however, also be another point on the vehicle which is not associated with a vehicle sensor as such, for example another point on said windshield, a point on a headlight or the like.

A fluid is a liquid or cleaning liquid. In the simplest case, it is water, but advantageously an aqueous cleaning agent solution, i.e. water in combination with a cleaning agent additive. Here, the cleaning agent solution may also advantageously contain an antifreeze agent, which as such lowers the freezing point of the cleaning agent solution.

A fluid also means air or ambient air, which is suitable, likewise pressurized, for cleaning the aforementioned cleaning surfaces.

However, a fluid should also be understood as meaning a mixture of the previously described cleaning liquid, in the simplest case only water, and air or ambient air.

Ambient air may also be understood to mean the air in a vehicle interior, the air expediently being filtered and possibly also preheated. In order to filter this vehicle interior air, use can advantageously be made of an air filter which is already provided in any case in an HVAC system (Heating, Ventilation and Air Conditioning→) or in an air conditioning system. This contributes to a reduction in costs.

The use of such preheated vehicle interior air or warm air has the advantage that freezing of the cleaning liquid at the respective cleaning point in the event of cold outside temperatures of a vehicle environment is counteracted, for example at a cleaning point which may be associated with sensor optics.

The term transversely (→transversely with respect to the supply line) is understood here as meaning that the individual fluidic connections between the outlet openings of the supply line and the electromagnets, through which the flow can pass, relative to the supply line, enclose or form an obtuse or acute angle, i.e. an angle greater than or less than 90°, or also represent an orthogonal arrangement, i.e. enclose or form an angle of 90°.

It is proposed that the flow can pass through an electromagnet assigned to one of the outlets transversely with respect to the supply line via an associated outlet opening of the supply line.

As a result, the pressurized fluid can be supplied from the central supply line as directly as possible to the respective outlets. Thus, advantageously, unnecessary and at the same time noticeable or significant or substantial hydraulic losses or friction losses, also called throughflow losses or throughflow pressure losses, which as such are accompanied by deflections of the fluid on the way from the central supply line to the respective outlet, are omitted.

By the proposed solenoid valve unit, these hydraulic losses can thus be advantageously reduced to a minimum by as direct a supply as possible of the fluid to the respective outlets transversely with respect to the supply line.

This further advantageously makes it possible to use weaker and commercially available fluid delivery units for providing a pressurized fluid in the supply line.

This proposed fluid-distributing mechanism simplifies a vehicle cleaning device or a vehicle cleaning system and thus reduces the costs associated therewith, because, by way thereof, it is possible to save on fluid delivery pumps and separate valve units. There is consequently also an associated weight saving. And since fluid delivery pumps are saved on, a corresponding activation of fluid pumps is also simplified.

This proposed fluid-distributing mechanism also reduces fluid consumption. This in turn is manifest in an increase in a range of a vehicle that can be achieved as such with one filling of a cleaning liquid container or tank. This applies in particular to future fully autonomously driving vehicles which, compared to previous vehicles, will have a significantly greater number of sensors—including safety-relevant sensors—the functionality of which has to be ensured, in particular with regard to the safety-relevant sensors.

Furthermore, the saving of required apparatus or system components also promotes corresponding compactness of such an apparatus or of such a system, such that overall less installation space is required.

In one aspect, the individual outlet openings of the supply line are arranged coaxially to an associated passage line, through which the fluid can pass, through the electromagnet. This all the more promotes a direct or virtually direct supply of the fluid to the respective outlets transversely with respect to the supply line.

In one aspect, the flow can pass through the electromagnets in each case via an internal valve piston, which acts as a closure body, with a passage line. It is proposed that a spring extends from the associated electromagnet into this passage line, via which spring the valve piston in an unenergized state of the electromagnet is applied preloaded against an associated outlet opening of the supply line and fluidically sealingly closes said outlet opening.

In one aspect, the passage line of the valve piston forks or branches toward a closure section of the valve piston into at least two line sections around the closure section, wherein the closure section together with associated housing sections of the solenoid valve unit forms said line sections.

The closure section of the valve piston is formed rotationally symmetrically, i.e., convexly, concavely and/or conically, at least in sections in order to fluidically sealingly close the associated outlet opening of the supply line. The closure section may be designed, for example, in the form of a ball.

It is proposed to design the surface of said closure section which is rotationally symmetrical, i.e. is convex, concave and/or conical, at least in sections, which surface is pressurizable by the supply line, to be as small as possible. This is because this minimization of the pressurizable surface of the closure section allows for a correspondingly cost-effective design of the electromagnets, because minimal magnetic forces to be applied to actuate the individual solenoid valves are sufficient to adjust the respective valve piston into an opening position counter to a spring acting thereon or acting in a restoring manner thereon.

The valve piston is formed from a magnetic material, for example from a plastic mixed with ferromagnetic particles or from a magnetized stainless steel or the like. In the case of a plastic mixed with magnetic particles, the closure section can be injection molded or integrally bonded to or alternatively also compressed with said plastic.

In one aspect, the solenoid valve unit has a central circuit board for contacting the individual electromagnets. Such a circuit board can be advantageously attached in a space-saving manner to one side or to a section of the solenoid valve unit, for example to the housing forming the supply line, by a joining connection and/or integrally bonded connection. In this case, a bus-activatable central electronic control unit can be formed or arranged on the circuit board such that the individual solenoid valves can be activated while avoiding separate cables.

In one aspect, the solenoid valve unit has at least one fluid delivery unit for providing the pressurized fluid.

The fluid delivery unit can be a liquid delivery pump having at least one pump stage or else a fluid delivery unit in the form of a so-called pump-compressor unit having at least one pump stage and at least one compressor stage, which is speed-controlled and/or speed-regulated to convey a liquid and/or air.

In one aspect, the solenoid valve unit has at least one first fluid delivery unit and a second fluid delivery unit of the type described above for providing the pressurized fluid. These fluid delivery units can be arranged fluidically in series and/or parallel to each other.

The use of a solenoid valve unit of the previously described type is furthermore proposed, wherein at least one of the solenoid valves is not fluidically connected to any of the cleaning points of the vehicle, in order, in the event of icing of the fluid in the central supply line, to reliably enable or to ensure a pressure equalization toward the environment.

In addition, a cleaning device for a vehicle having a solenoid valve unit of the type described above is proposed.

Also proposed is a vehicle having such a cleaning device.

A vehicle should be understood here to mean any type of vehicle that is operated either by internal combustion engine and/or electric motor, but in particular passenger vehicles and/or utility vehicles. These are preferably partially autonomously and in particular fully autonomously operated vehicles.

### BRIEF DESCRIPTION OF THE DRAWINGS

The invention will be explained in detail below with reference to the illustrations in the figures. Further advantageous developments of the invention are apparent from the dependent claims and from the description below of preferred embodiments. For this purpose:

FIG. 1 is a first perspective view of a proposed solenoid valve unit;

FIG. 2 is a second perspective view of a solenoid valve unit shown in FIG. 1;

FIG. 3 is a third perspective view of a solenoid valve unit shown in FIG. 1;

FIG. 4 is a perspective view of a pair of solenoid valves of the solenoid valve unit shown in FIGS. 1 to 3; and

FIG. 5 is a sectional view of a solenoid valve of the solenoid valve unit shown in FIGS. 1 to 3.

### DETAILED DESCRIPTION OF THE PRESENTLY PREFERRED EMBODIMENTS

The proposed solenoid valve unit 2 is provided for a cleaning device of a vehicle and serves to supply individual cleaning points of the vehicle with a pressurized liquid or cleaning liquid. This solenoid valve unit 2 acts in the sense of a distributor, which distributes the liquid to the individual cleaning points via one of the illustrated outlets A₁, A₂, . . . , A₉, A₁₀ each.

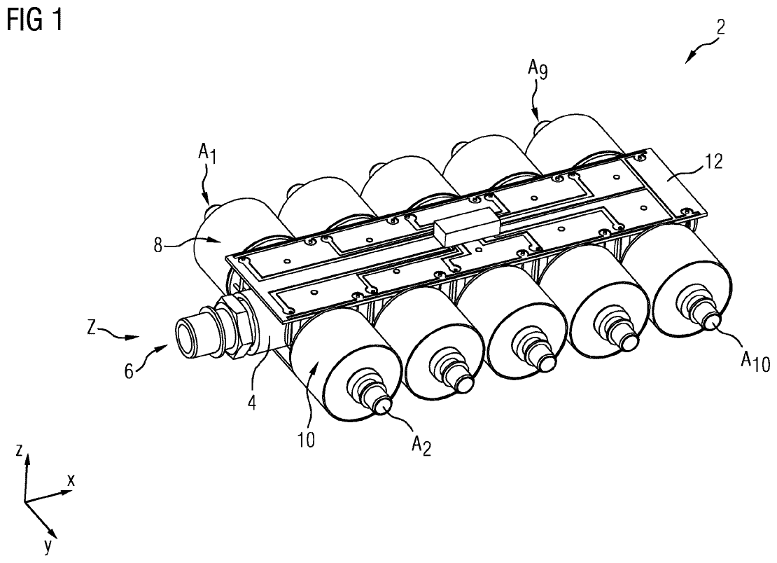

The solenoid valve unit 2 has a housing 4 with an inlet Z, via which the liquid provided by a liquid delivery pump or pump—not shown here—is supplied to a central supply line 6 in the housing 4. Merely by way of example, a total of ten solenoid valves 8, 10, . . . are shown by FIG. 1 as components of said solenoid valve unit 2. On the top side of the solenoid valve unit 2 shown in FIG. 1, a circuit board 12 arranged between the individual solenoid valves 8, 10, . . . is provided in a space-saving manner on the housing 4, which circuit board extends over the entire solenoid valve unit 2 between the individual electromagnets EM₁, EM₂ . . . EM₉, EM₁₀ of the respective solenoid valves 8, 10, . . . and is electrically connected with said electromagnets EM₁, EM₂ . . . EM₉, EM₁₀. Via a central electronic control unit, which is arranged on the circuit board 12, the individual solenoid valves 8, 10, . . . can be correspondingly individually activated with separate cables being avoided.

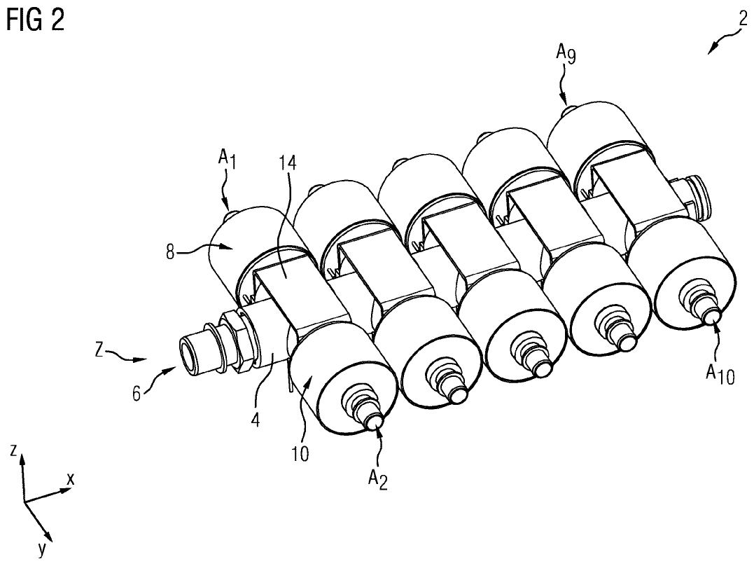

FIG. 2, on the other hand, shows, by way of example, a type of possible positionally fixed securing or fixing of the individual solenoid valves 8, 10, . . . with respect to the housing 4, specifically by individual clamps 14, which are provided in each case between two mutually opposite solenoid valves 8, 10, . . . , between which the housing 4 is located and secure or fix the solenoid valves 8, 10, . . . relative to the housing 4. Said clamps 14 engage in undercuts or recesses of associated housing sections, in particular plastics housing sections of the respective solenoid valves 8, 10, . . . , such that the individual solenoid valves 8, 10, . . . are reliably secured or fixed relative to the housing 4.

Instead of the individual clamps 14, a single and correspondingly larger clamp could also be provided for the purpose of this securing, which clamp engages in said undercuts or recesses in an analogous manner via corresponding gripping sections.

In addition or as an alternative to such a form-fitting connection, the positional securing of the individual solenoid valves 8, 10, . . . to the housing 4 could also be reliably achieved via local welding—or at least via a local integrally bonded connection—of the solenoid valves 8, 10, . . . .

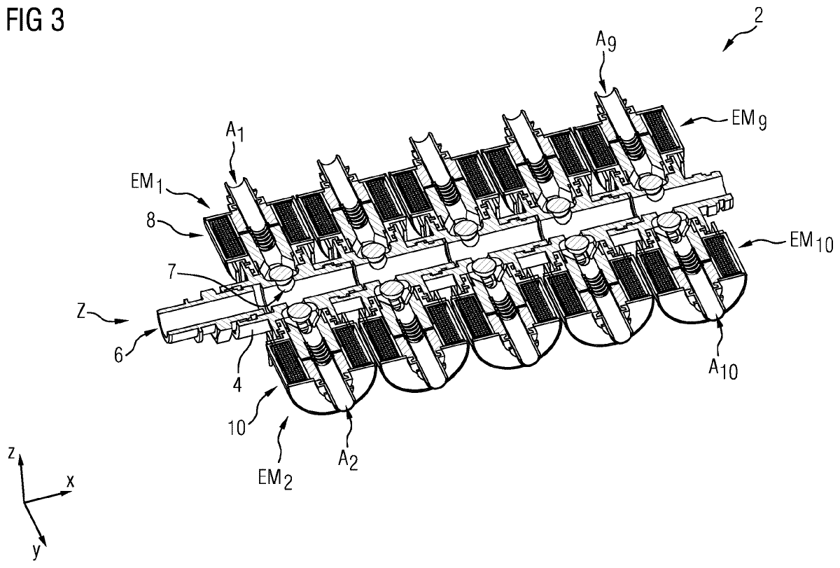

FIG. 3 illustrates very nicely that the flow can pass transversely with respect to the supply line 6 and virtually directly through an electromagnet EM₁, EM₂ . . . EM₉, EM₁₀ assigned to one of the outlets A₁, A₂, . . . , A₉, A₁₀ via an associated outlet opening 7 of the supply line 6. Starting from the supply line 6, there is thus almost no or no significant deflection of the liquid as far as the respective outlet A₁, A₂, . . . , A₉, A₁₀, and therefore hydraulic losses associated with such a deflection, also called throughflow pressure losses, are advantageously omitted or reduced to an absolute minimum.

The proposed solenoid valve unit 2 thus allows as direct a flow as possible through the individual electromagnets EM1, EM2 . . . EM9, EM10 transversely with respect to the supply line 6.

For such a flow-as directly as possible-through the individual electromagnets EM1, EM2 . . . EM9, EM10, it is also proposed to arrange the individual solenoid valves 8, 10, . . . orthogonally to the supply line 6 and to join them to the housing 4. This permits a highly compact or space-saving solution of a liquid-distributing mechanism.

Such a direct flow through the individual electromagnets EM1, EM2 . . . EM9, EM10 is also promoted by the fact that the individual outlet openings 7 are arranged coaxially to the associated passage line through the respective electromagnet EM1, EM2 . . . EM9, EM10.

The solenoid valve unit 2 illustrated in FIGS. 1 to 3 is also a liquid-distributing mechanism without any liquid leakage within the housing 4. Although the valve pistons 18 with their spherical closure section 26 are movable relative to the housing 4, 4g, the closure sections 26 form a gap with respect to the associated housing section 4g, via which the pressurized fluid can flow, only in an opening position of the associated valve piston 18,. As a result, there is no need for a fluid delivery pump or fluid delivery pumps, which has or have to contain liquid leaks as such. Thus, the proposed solenoid valve unit 2 contributes to the saving on energy.

The solenoid valve unit 2 illustrated in FIGS. 1 to 3 is also a highly compact or space-saving solution of a liquid-distributing mechanism.

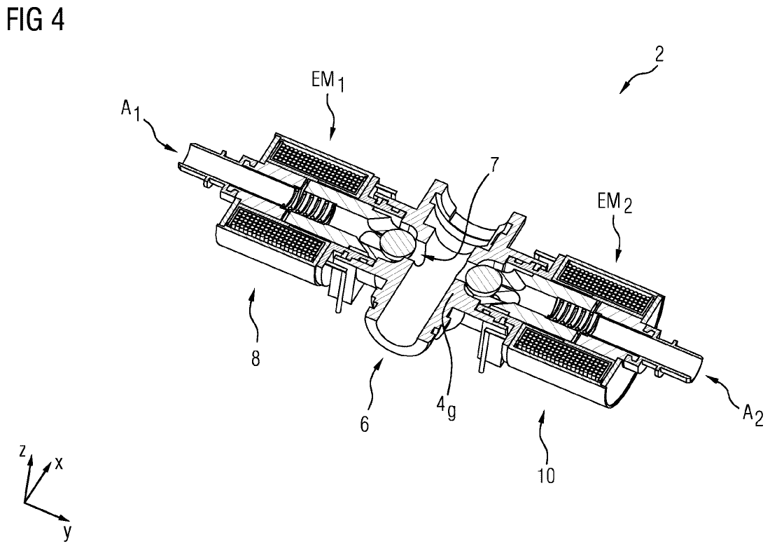

A further advantage of this proposed solenoid valve unit 2 results from its modular construction (cf. FIG. 4), which as such provides a high degree of flexibility. It is proposed that two solenoid valves 8, 10, . . . , which lie opposite each other and are arranged transversely with respect to the supply line 6 and between which the supply line 6 is located, form a modularly extended pair of solenoid valves, the common housing portion 4g of which is extended either at one end or at both ends of the supply line 6 by a housing section 4g of a further pair of solenoid valves by a joining connection and/or an integrally bonded connection.

Said joining connection between two housing sections 4g joined to each other is designed by way of example in the form of a bayonet connection.

Analogously thereto, in a further embodiment, not shown here, the individual solenoid valves 8, 10, . . . can also be joined or connected to the associated housing section 4g by such a bayonet connection and can thereby be secured relative to the housing section 4g or the housing 4.

Both the joining connections between individual solenoid valves 8, 10, . . . and the respectively associated housing sections 4g and also the joining connections between the individual housing sections 4g are designed to be sufficiently fluidically sealing by corresponding seals, for example in the form of O-rings.

This proposed modularity allows flexible use of a so-called modular system from which—depending on requirements or depending on need—an arbitrarily large solenoid valve unit 2 in the sense of a liquid-distributing unit can be assembled as required and optimized in terms of costs.

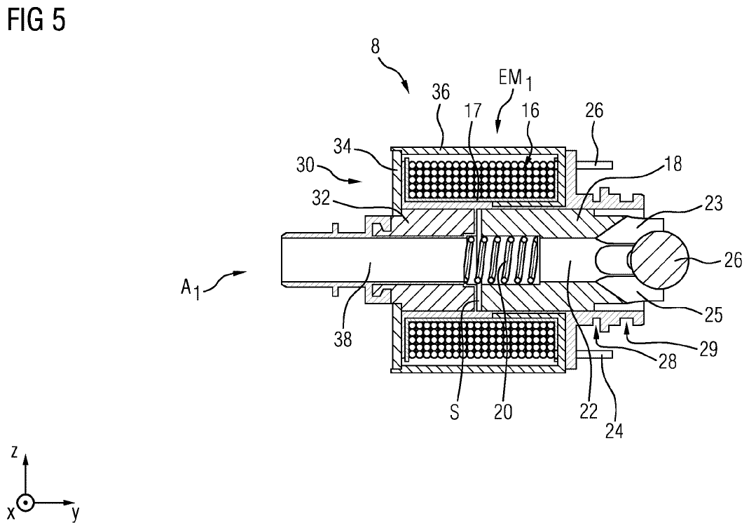

The flow can pass through the electromagnets EM1, EM2 . . . EM9, EM10 in each case via an internal valve piston 18, which acts as a closure body, with a passage line 22 (cf. FIG. 5). Within the respective electromagnet EM1, EM2 . . . EM9, EM10, a helical spring 20 extends into said passage line 22, via which helical spring the valve piston 18 in an unenergized state of the electromagnet EM1, EM2 . . . EM9, EM10 is applied preloaded against an associated outlet opening 7 of the supply line 6 and fluidically sealingly closes said outlet opening.

Said passage line 22 branches or forks toward a closure section 26—of the valve piston 18—in the form of a ball into at least two line sections 23, 25 around the closure section 26. Said closure section or said ball 26 forms said line sections 23, 25 with associated plastics housing sections of the respective solenoid valve 8, 10, . . . and with associated plastics housing sections of the respective common housing section 4g. The individual valve pistons 18 are advantageously formed from a plastic with magnetic particles, such as ferromagnetic particles, which plastic is connected in an integrally bonded manner or injection molded to the respective ball 26.

Accordingly, said ball 26 together with the respective line sections 23, 25 is a hydraulic section, which causes a slight deflection of the liquid. In addition, nothing obstructs the above-mentioned direct flow through the respective solenoid valves 8, 10, . . . or the respective electromagnets EM1, EM2 . . . EM9, EM10.

As an alternative to such a plastics formation, the valve piston 18, for example, can also be formed from a ferromagnetic metal or from a stainless, magnetized steel and joined and/or connected in an integrally bonded manner to the ball 26 or to an alternative closure section, which has a rotational body section formed convexly, concavely and/or conically at least in sections for closing the associated outlet opening 7.

By use of such a ball 26 or a closure section formed alternatively thereto and having a concavely, convexly and/or conically formed closure surface, the associated outlet opening 7 of the supply line 6 can be reduced to a minimum. Thus, even in a closed position of the valve piston 18, a closure surface of the valve piston 18 that is pressurized with the liquid by the supply line 6 can be reduced to a minimum. In association therewith, the restoring helical spring 20 and the respective electromagnet EM1, EM2 . . . EM9, EM10 can be designed to be optimized in terms of force. This in turn permits the costs of such a solenoid valve unit 2 to be kept to a minimum, because it is the individual electromagnets EM1, EM2 . . . EM9, EM10 which substantially influence the costs and drive them upward.

The proposed valve piston 18 or its closure section or ball 26 thus enables a force-and stroke-optimized design or dimensioning of the individual solenoid valves 8, 10, . . . owing to a smallest possible closure surface, on which the pressurized liquid in the supply line acts.

FIG. 5 illustrates the solenoid valve 8 with the electromagnet EM1, which comprises a coil former 16 with a wire winding or coil winding made of, for example, copper and a wire winding carrier or coil carrier 17 made of plastic and by which the wire winding is held. The wire winding carrier 17 is injection molded to the wire winding. On one of the two end faces of the wire winding carrier 17, a first wire end or coil end 24 and a second wire end or coil end 26 extend through the plastic of the wire winding carrier 17 and, for example, as far as the circuit board 12, with which the wire ends 24, 26 are in contact. Alternatively thereto, each of the electromagnets EM1, EM2 . . . EM9, EM10 shown in FIGS. 1 to 3 can be equipped with a separate socket, via which said wire ends can be contacted with a corresponding plug.

The electromagnet EM1 furthermore has a metallic return pot 30, for example made of iron or steel, to which the coil former 16 is joined. The return pot 30 comprises a first, central and socket-like pot section 32, which forms a passage line 38 to the outlet A1 and thus said passage line through the electromagnet EM1, a second pot section 34 adjoining the first pot section 32, and a third pot section 36 which adjoins the second pot section 34 and is joined to the coil former 16. In the passage line through the electromagnetic EM1, said helical spring 20 is arranged lying and preloaded against a first spring seat in the passage line 38 and against a second spring seat in the passage line 22, and therefore the valve piston 18 in an unenergized state of the electromagnet EM1 is applied preloaded against the associated outlet opening 7 of the supply line 6 and fluidically sealingly closes said outlet opening.

The arrangement, illustrated in FIG. 5, of the return pot 30 and coil former 16 is also injection molded in sections with a plastic, which on the one hand forms a plastics section, which can be joined to the common housing section 4g and through which the valve piston 18 is introduced into the solenoid valve 8 until just before the socket-like pot section 32, and a plastics section for the outlet A1 of the solenoid valve 8. This plastics overmolding not only connects the metallic pot sections forming the return pot 30 to the coil former 16, but also protects these metallic sections and components from corrosion.

On the plastics section of the solenoid valve 8, which plastics section can be joined to the common housing portion 4g, an undercut or recess 28 for interaction with the previously described clamp 14 and an undercut or recess 29 for receiving a sealing ring, for example in the form of an O-ring, can also be seen.

The gap S between the valve piston 18 and the pot section 32 limits the possible stroke of the valve piston 18. In the event of icing of the liquid in the central supply line 6, said gap S advantageously ensures or enables so-called icing compensation or so-called icing protection of the solenoid valve unit 2. In this case, an icing-related movement of the liquid through the valve piston 8 or beyond the valve piston 8 is made possible in order to prevent icing-related damage to the respective solenoid valve 8 and/or to the supply line 6.

In this respect, the proposed solenoid valve unit 2 with respect to each of the solenoid valves 8, 10, . . . provides a corresponding compensation or pressure compensation possibility, and therefore the individual solenoid valves 8, 10, . . . can counteract icing-related damage to the proposed solenoid valve unit 2.

An advantageous use of the previously described solenoid valve unit 2 is also proposed in a configuration in which at least one of the solenoid valves 8, 10, . . . has not been or is not connected to any of said cleaning points of the vehicle. As a result, icing-related damage to the solenoid valve unit 2 can be avoided or prevented even more reliably, because there is no liquid on the outlet side of the non-connected solenoid valve and therefore it also cannot be iced up. This enables reliable pressure equalization to the environment in order to prevent icing-related damage to the respective solenoid valve 8 and/or to the supply line 6.

The individual plastics housing parts 4g and the individual plastics sections of the respective solenoid valves 8, 10, . . . . . . are manufactured, for example, from a thermosetting plastic or thermoplastic—for example, from a PPS-GF material.

The solenoid valve unit 2 illustrated in FIG. 4 in the sense of a smallest possible basic unit of the solenoid valve unit 2 shown in FIGS. 1 to 3 shows a pair of solenoid valves, the solenoid valves 8, 10, . . . of which are arranged lying opposite each other at an angle of 180° and coaxially to each other. This arrangement allows a simple securing of the two solenoid valves 8, 10, . . . to the common housing section 4g, for example by the aforementioned clamp 14.

As an alternative to such an arrangement, the solenoid valves 8, 10, . . . can also be arranged in such a way relative to each other and lying opposite each other and joined to the common housing section 4 g in such a way that they enclose an obtuse angle greater than 90° and less than 180° or an acute angle of less than 90° with each other, without losing the previously described advantageous nature of a modular system. This makes the proposed solenoid valve unit 2 all the more flexible, depending on installation space conditions.

In a further embodiment—not shown here—at least one housing section 4g of one of the pairs of solenoid valves shown in FIGS. 1 to 3 have a so-called partition wall section, which divides the central supply line 6 shown in FIG. 3 into at least two regions. In this embodiment, the housing 4 has at least one first supply line or a first supply line section and a second supply line or a second supply line section, each having an associated inlet.

This even makes it possible to operate at least two different pressure ranges with at least one associated liquid delivery pump each, e.g., a first supply line section at e.g., 3 bar and a second supply line section at e.g., 5 bar. This is another aspect indicating the flexibility of the proposed solenoid valve unit 2.

The proposed solenoid valve unit 2 is a liquid-distributing mechanism or a type of liquid distributor with throughflow pressure losses or hydraulic losses reduced to a minimum.

Thus, this proposed solenoid valve unit 2 promotes high performances of a vehicle cleaning device, which as such has such a solenoid valve unit 2. Owing to the high liquid pressures that can be utilized in this case, liquid consumption of the vehicle cleaning device can advantageously be reduced to a minimum. As a result, the liquid delivery pumps used in this process essentially only have to compensate for the smallest losses of the solenoid valve unit 2.

Although exemplary embodiments are explained in the above description, it should be noted that numerous modifications are possible. Furthermore, it should be noted that the exemplary embodiments are merely examples which are in no way intended to limit the scope of protection, the applications, and the structure. Instead, the above description gives a person skilled in the art a guideline for the implementation of at least one exemplary embodiment, it being possible to make various changes, especially with regard to the function and arrangement of the component parts described, without departing from the scope of protection as emerges from the claims and combinations of features that are equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-18. (canceled)

19. A solenoid valve unit configured to distribute a pressurized fluid to individual cleaning points of a device, comprising:
at least four solenoid valves each having an and each being fluidically connectable via an associated outlet to one of the cleaning points; and
a housing having at least one central supply line with at least one fluid inlet configured to provide the pressurized fluid in the supply line, wherein the solenoid valves are joined to the housing transversely with respect to the supply line,
wherein two solenoid valves, which lie opposite each other and are arranged transversely with respect to the at least one central supply line and between which the at least one central supply line is located, form a modularly extended pair of solenoid valves, a common housing portion of which is extended either at one end or at both ends of the at least one central supply line by a housing section of a further pair of solenoid valves by a joining connection and/or an integrally bonded connection.

20. The solenoid valve unit as claimed in claim 19, wherein the individual solenoid valves are joined/connected to the housing by a joining connection and/or integrally bonded connection.

21. The solenoid valve unit as claimed in claim 20, wherein the joining connection is a bayonet connection.

22. The solenoid valve unit as claimed in claim 19, wherein a flow can pass through an electromagnet assigned to one of the outlets transversely with respect to the supply line via an associated outlet opening of the supply line.

23. The solenoid valve unit as claimed in claim 22, wherein the outlet opening is arranged coaxially to a passage line, through which the fluid can pass, through the electromagnet.

24. The solenoid valve unit as claimed in claim 19, wherein a flow can pass through the electromagnets in each case via an internal valve piston, which acts as a closure body, with a passage line.

25. The solenoid valve unit as claimed in claim 24, wherein a spring extends from the associated electromagnet into this passage line, via which spring the valve piston in an unenergized state of the electromagnet is applied preloaded against an associated outlet opening of the supply line and fluidically sealingly closes said outlet opening.

26. The solenoid valve unit as claimed in claim 25, wherein the passage line forks toward a closure section of the valve piston into at least two line sections around the closure section, wherein the closure section together with associated housing sections of the solenoid valve unit forms said line sections.

27. The solenoid valve unit as claimed in claim 26, wherein the closure section is formed rotationally symmetrically at least in sections for fluidically tight closing of the associated outlet opening of the supply line.

28. The solenoid valve unit as claimed in claim 27, wherein the valve piston is formed from a magnetic material.

29. The solenoid valve unit as claimed in claim 28, wherein the valve piston is formed from a plastic with magnetic particles, which plastic is connected to the closure section in an integrally bonded manner.

30. The solenoid valve unit as claimed in claim 19, wherein the solenoid valve unit has a central circuit board for contacting the individual electromagnets.

31. The solenoid valve unit as claimed in claim 19, wherein the solenoid valve unit has at least one fluid delivery unit for providing the pressurized fluid.

32. The solenoid valve unit as claimed in claim 31, wherein the solenoid valve unit has at least one first fluid delivery unit and a second fluid delivery unit for providing the pressurized fluid.

33. The solenoid valve unit as claimed in claim 32, wherein the fluid delivery units are arranged fluidically in series and/or parallel to each other.

34. The solenoid valve unit as claimed in claim 19, wherein at least one of the solenoid valves is not fluidically connected to any of the cleaning points of a vehicle, in order, in event of icing of the fluid in the central supply line, to enable a pressure equalization toward an environment.

35. A cleaning device for a vehicle having a solenoid valve unit comprising:
at least four solenoid valves each having an electromagnet and each being fluidically connectable via an associated outlet to one of a plurality of cleaning points; and
a housing having at least one central supply line with at least one fluid inlet configured to provide a pressurized fluid in the supply line, wherein the solenoid valves are joined to the housing transversely with respect to the supply line,
wherein two solenoid valves, which lie opposite each other and are arranged transversely with respect to the at least one central supply line and between which the at least one central supply line is located, form a modularly extended pair of solenoid valves, a common housing portion of which is extended either at one end or at both ends of the at least one central supply line by a housing section of a further pair of solenoid valves by a joining connection and/or an integrally bonded connection.

36. A vehicle having a cleaning device having a solenoid valve unit comprising:
at least four solenoid valves each having an electromagnet and each being fluidically connectable via an associated outlet to one of a plurality of cleaning points; and
a housing having at least one central supply line with at least one fluid inlet configured to provide a pressurized fluid in the supply line, wherein the solenoid valves are joined to the housing transversely with respect to the supply line,
wherein two solenoid valves, which lie opposite each other and are arranged transversely with respect to the at least one central supply line and between which the at least one central supply line is located, form a modularly extended pair of solenoid valves, a common housing portion of which is extended either at one end or at both ends of the at least one central supply line by a housing section of a further pair of solenoid.
